(19) United States
(12) Patent Application Publication
(10) Pub. No.: US 2013/0040738 A1
(43) Pub. Date: Feb. 14, 2013

(54) Moble gambling, gaming, wagering and lottery platform

(71) Applicants: John Mikkelsen, Minneapolis, MN (US); Robert Freidson, St. Petersburg (RU); John P. Luther, Chicago, IL (US)

(72) Inventors: John Mikkelsen, Minneapolis, MN (US); Robert Freidson, St. Petersburg (RU); John P. Luther, Chicago, IL (US)

(21) Appl. No.: 13/573,393

(22) Filed: Sep. 13, 2012

Related U.S. Application Data
(63) Continuation-in-part of application No. 12/322,615, filed on Feb. 4, 2009.
Application No. 12/322,615 is a continuation of application No. 10/183,756, filed on Jun. 26, 2002, now Pat. No. 7,548,875.
Application No. 10/183,756 is a continuation-in-part of application No. 12/322,618, filed on Feb. 4, 2009.
Application No. 12/322,618 is a division of application No. 10/183,756, filed on Jun. 26, 2002, now Pat. No. 7,548,875.
Application No. 10/183,756 is a continuation of application No. 12/322,610, filed on Feb. 4, 2009.
Application No. 12/322,610 is a continuation-in-part of application No. 10/183,756, filed on Jun. 26, 2002, now Pat. No. 7,548,875.
Application No. 10/183,756 is a continuation of application No. 12/456,346, filed on Jun. 15, 2009, now abandoned.
Application No. 12/456,346 is a continuation-in-part of application No. 10/183,756, filed on Jun. 26, 2002, now Pat. No. 7,548,875.
Application No. 10/183,756 is a division of application No. 12/592,532, filed on Nov. 25, 2009.
Application No. 12/592,532 is a continuation-in-part of application No. 10/183,756, filed on Jun. 26, 2002, now Pat. No. 7,548,875.
(60) Provisional application No. 60/301,681, filed on Jun. 27, 2001.
(60) Provisional application No. 60/303,115, filed on Jul. 3, 2001.
(60) Provisional application No. 60/312,450, filed on Aug. 14, 2001.
(60) Provisional application No. 60/343,159, filed on Oct. 26, 2001.
(60) Provisional application No. 60/301,681, filed on Jun. 27, 2001.
(60) Provisional application No. 60/303,115, filed on Jul. 3, 2001.
(60) Provisional application No. 60/312,450, filed on Aug. 14, 2001.
(60) Provisional application No. 60/343,159, filed on Oct. 26, 2001.
(60) Provisional application No. 60/301,681, filed on Jun. 27, 2001.
(60) Provisional application No. 60/303,115, filed on Jul. 3, 2001.
(60) Provisional application No. 60/312,450, filed on Aug. 14, 2001.
(60) Provisional application No. 60/343,159, filed on Oct. 26, 2001.
(60) Provisional application No. 60/301,681, filed on Jun. 27, 2001.
(60) Provisional application No. 60/303,115, filed on Jul. 3, 2001.
(60) Provisional application No. 60/312,450, filed on Aug. 14, 2001.
(60) Provisional application No. 60/343,159, filed on Oct. 26, 2001.
(60) Provisional application No. 60/301,681, filed on Jun. 27, 2001.
(60) Provisional application No. 60/303,115, filed on Jul. 3, 2001.
(60) Provisional application No. 60/312,450, filed on Aug. 14, 2001.
(60) Provisional application No. 60/343,159, filed on Oct. 26, 2001.

(51) Int. Cl. G06F 19/00

(52) U.S. Cl. 463/41

(57) ABSTRACT

Provided is an electronic gambling, gaming, wagering and lottery content playing method and system comprising:
a storage medium effective to store gambling, gaming, wagering and lottery content files, including sound content files, image content files, or a combination thereof, in compressed format,
an electronic device having telephone capability and service provider connectivity comprising a receiver means which receives said content files delivered on demand in compressed format from a remote server with or without an Internet connection; and
a player located on the electronic device which can selectively play said content files, and wherein said content files are interactive in the form of a live casino, bingo or lottery operation.

### CROSS-REFERENCES TO RELATED APPLICATIONS

This is a continuation-in-part application of Ser. No. 12/322,615, filed Feb. 4, 2009 and Ser. No. 12/322,618, filed Feb. 4, 2009, continuation and divisional applications, respectively, and U.S. application Ser. No. 12/322,610 filed Feb. 4, 2009, Ser. No. 12/456,346, filed Jun. 15, 2009, and Ser. No. 12/592,532, filed Nov. 25, 2009, continuation-in-part applications, all of which claim priority to U.S. application Ser. No. 12/183,756, now U.S. Pat. No. 7,548,875, which claims priority to U.S. Provisional Application Ser. No. 60/301,681 filed on Jun. 27, 2001, U.S. Provisional Application Ser. No. 60/303,115 filed on Jul. 3, 2001, U.S. Provisional Application Ser. No. 60/312,450 filed on Aug. 14, 2001, and U.S. Provisional Application Ser. No. 60/343,159 filed Oct. 26, 2001, all of which applications and patents are incorporated herein by reference thereto.

### TECHNICAL FIELD

This invention relates to a method of delivery and play of gambling, wagering, and other related subject matter, inclusive of all forms of gambling, such as slots, card games, table games, keno, bingo, sports book and sports betting, horse and dog racing, exchange betting, sweepstakes, lotteries and scratch-offs, and handicapping services as well, with accompanying sound and image files for wireless and non-wireless electronic devices with telephone capability, and which may be dependent or independent of an Internet connection.

### BACKGROUND

Presently, various methods have been developed and are being used to enable phone users, particularly cell phone users given their hugely widespread presence, to make more effective use of the variety of telephone services now available. One such rapidly emerging industry is mobile gambling, gaming and wagering which is already a multimillion dollar industry, or a multibillion dollar industry in some geographic areas, and is expected to see dramatic growth in the near future. Some reports predict a twenty billion dollar industry in 2010, and others suggest a staggering forty-four billion dollar industry by 2011.

New technologies are also boosting the growth in mobile gambling and gaming such as the introduction of touch screens, high-speed data networks, faster processors and cameras. Some examples of new mobile gaming and gambling technologies methods and systems are described, for example, in U.S. Pat. No. 7,534,169; U.S. Pat. No. 7,510,474; U.S. 2009/0275413; U.S. 2007/0060306; U.S. 2005/0181875; U.S. 2004/0162124; 2007/0270224; U.S. 2008/0076572; U.S. 2002/0147049; U.S. Pat. No. 5,999,808; U.S. 2009/0247226; and U.S. 2008/0146337.

While all of such new methods and systems are no doubt effective, there remains much room for improvement and versatility in this exciting and rapidly emerging industry, especially in the wireless and Internet-less arena, where the need for an Internet connection and or ISP connection is optional or not needed, and where a cell phone user can access gambling, gaming, lottery and other wagering, gambling-type and handicapping activities wirelessly without the need for a PC or laptop or other such devices, and likewise can be reached by wagering, gambling hosting, handicapping and service provider sites essentially at will, anytime and anyplace where there is wireless or wireline service provider accessibility, which covers most of the world populace and is growing.

### SUMMARY OF INVENTION

The present invention provides an improved method for delivery and play of sound and image files associated with all forms of gambling content and activities, inclusive of slots, table games, card games, sports book and sports betting, keno, bingo, gaming, horse and dog racing, exchange betting, sweepstakes, lotteries and scratch-offs and any other form of gambling and wagering activities including handicapping activities (hereinafter “gambling content files”) and which may include and/or be associated with other rich media content, such as, for example, songs, musical compositions, and other sound recordings, cartoons, movies, television shows, or any other type of performance, and personal recordings, such as personal sound recordings, animations and the like, and any form of audio and visual content, including any and all forms of advertising subject matter, such as experienced in an actual live casino or an on-line Internet accessed casino content.

The present method, system and products provide the consumer with a unique way of accessing and browsing through selectable gambling content files associated with or in conjunction with other rich media sound and visual files, and which may be accessed, delivered and interactively played for money or amusement, either wirelessly or via traditional wireline telephony, and be Internet-based or independent of the Internet. Algorithms are provided for the delivery, storage and playback of the sound and image files, inclusive of gambling and lottery content. The present invention also includes the wireless downloading of various applications including any and all sorts or versions of gaming and gambling applications and lottery applications.

The present methods, system and products of the invention are more fully described in the following detailed discussion with accompanying drawings.

### BRIEF DESCRIPTION OF DRAWINGS

FIG. 1 is a frontal plan view of a cellular phone illustrating a typical layout of a form of an example gambling content embodiment depicted on a cell phone screen in accordance with the invention in the form of a slot machine play display.

FIG. 2 is a frontal plan view of a cellular phone with a typical form of an example gambling content embodiment depicted on its screen in the form of a card game gambling operation, i.e. poker.

FIG. 3 is another frontal plan view of a cellular phone with a typical form of an example gambling content embodiment depicted on its screen in the form of a roulette gambling operation.

FIG. 4 is a yet another frontal plan view of a cellular phone with a an example form of gambling content embodiment depicted on its screen, in the form of a card game, i.e. blackjack gambling operation.

FIG. 5 is a flowchart of a block diagram of a gambling operation example embodiment showing exemplified functional components thereof.

### DETAILED DESCRIPTION OF THE INVENTION

The detailed description set forth below in connection with the appended drawings is intended as a description of presently-preferred embodiments of the invention and is not intended to represent the only forms in which the present invention may be constructed and/or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention.

The present invention uses a unique method for storage, delivery and play of interactive gambling content files, optionally accompanied by other rich media audio and visual files, in conjunction with electronic devices having telephony capability and service provider connectivity, and which files may also include, for example, without limitation, songs, musical compositions, or other sound and image content such as, without limitations, cartoons, animation, movies, television shows, or any other type of performance, as well as personal content files, such as typically encountered in a live casino operation or Internet casino experience. This method and system includes the use of gambling content in a variety of electronic equipment with telephone service provider connectivity, and provides the consumer with a unique way of accessing such gambling content files wirelessly or by wireline, and which may be Internet-based or independent of the Internet.

In one aspect, the present invention may include a number of modules for an overall system of delivery of gambling content files inclusive of audio/visual rich media files. These modules include a server or servers of the files which may be accessible by way of a website for viewing, selecting, sampling and downloading selected files or portions thereof, or directly accessible through one or more servers, such as a gambling content hosting site or provider, without going through a website and without the need for an Internet connection or ISP provider. A telephone, be it a conventional phone, cell phone or other hand held device with telephony capability and with access to a communication network, can access the server either directly or through the website. Algorithms allow the transfer of the files to the handset. The individual elements of the invention are unique as well as the overall system of delivery. Described below are more detailed aspects of the invention and its use.

The gambling content may be garnered from or based on any of such gambling, gaming, or wagering activities that are used or employed in actual casinos, either live or Internet-based, including without limitation, slot machines, poker, video poker, keno, card games, and the like, and any other conventional type gambling activities, such as, for instance, lotteries, bingo parlors, and the like, and accompanying sound and visual files may be lifted from CD's, movies, TV shows, and the like, optionally preferably from actual recordings, which may include human voice, instrument sound, and other sound and visual effects such as to give the effect and/or experience of an actual live casino or Internet-based casino.

A cellular phone or similar device having one or more processors, inclusive of a DSP pro-cessor, or processing capability inclusive of digital signal processing capability and also preferably including or comprising RAM and flash elements may be integrated with software at the time of manufacturing for implementing the system of the present invention in a device. Alternatively, a chip including elements as discussed below may preferably be embedded into the device, including a speaker, or in an accessory device which may be attached to the device for implementing the system (and for providing optional additional processing capability), and methods of the present invention. The accessory unit may have an adapter connection to the device. Such accessory unit may be sold with several adapter outlets to enable it to fit onto a variety of different electronic devices as the case may be.

In another aspect of the invention, gambling content files may be pre-stored on the electronic device or accessory unit at the time of manufacturing, such that the consumer may be able to purchase a phone device expressly for the purpose of gambling, e.g. a “gambling phone” such as a slot machine phone, lottery phone, or sports betting phone and the like having telephone capability, without first having to select and download gambling content files. Such “gambling phones” could be purchased at a local 7-Eleven or other general purpose store or retail location and the like, just as a lottery ticket or scratch-off ticket is conventionally purchased, except that it enables as an option a telephone connection to a payoff server or other connection, such as to a bank for funds processing and/or availability as more fully discussed below.

In a further aspect of the invention, a user of an electronic device, according to the present invention, may download and store a number of gambling content files off of a website via a plug-in connection of the device to a computer, or via a wireless network system such as the Apple® Airport. Additionally, in yet another aspect of the invention, a non-Internet based holding system, and which may be especially adapted for delivering gambling content files to the electronic device or accessory unit may also be provided. Such holding system may be accessed via a phone dial, e.g., a push button sequence from a cell phone keypad in connection wherein a user may interact with the holding system by using the phone keypads or voice commands. Other controls for interacting with the holding system, such as control buttons, voice commands or text keypads, may be provided on the accessory unit or the electronic device itself which may be especially adapted for interacting with such holding system. The accessory unit or electronic device itself may also be sold preprogrammed with embedded gambling content files for demonstration use.

Additionally, such electronic devices may be capable of receiving or sending gambling content files directly from one device to another device.

In yet a further aspect of the invention, an electronic device having stored sound or image gambling content files may include various features which allow the user to preprogram the gambling content files to play in a set sequence or a random order. Additionally, the device may have features allowing the user to classify and arrange the gambling content files based on categories such as the type of gambling content files (i.e., slot machines, video poker, card games, etc.

It is also contemplated that a user of an electronic device utilizing the gambling content files according to the present invention will be able to arrange such files either through a website from which the gambling content files can be downloaded onto the device, or through the device itself, or from a hosting server independent of the Internet.

Advertisements may also be transmitted to electronic devices according to the present invention. A message such as “pick up the phone and don't forget to drink Coca Cola™” or any other form of advertising and/or marketing content may be used during a gambling session, or before or after a gambling session, gaming, wagering or lottery session.

### Accessing of Gambling Content Files Inclusive of Sound and/or Image Files without Access to Internet

Sound and/or image files which include gambling content files may be downloaded without use of the Internet by allowing a user to access a library of gambling content files via a cellular phone or home telephone or providing other electronic devices with features which allow access to the library. Although Internet free accessing will be described with respect to a telephone, it is to be understood that the method described may be compatible with any electronic device preferably having accessing capabilities similar to a telephone.

The library may be a non-web holding unit that has files with associated codes which match the codes associated with the files on a website, wherein the website serves as a usable guide for identifying various files according to associated codes, such as numerical codes to assist the user in downloading files using voice commands or keypad commands.

Additionally, cellular phone or home telephone users may access a non-web holding unit with a library of stored files which can similarly be browsed, selected, and downloaded onto the phone using user voice commands, key pad commands, or by connection to a live operator. Such unit may be accessed by dialing a phone number (e.g., an 800 number). Home telephones and cellular phones may have separate holding units, such as a satellite for cellular phones and a ground unit for home phones, or a satellite can be used by cellular phones to access a ground holding unit.

To facilitate selection of the files from such holding unit, the access system may provide for a code associated with each file which may be obtained by browsing the website as described above. As such, a user connected to the holding unit would access the code associated with the file to select and download the file to the user's telephone.

Many other methods allowing a user to select files from the holding unit are possible. For example, the telephone may include a voice recognition feature, wherein the user can say the name or part of the name of the gambling content file he wishes to select (e.g., a particular casino game, such as a one, two, three or more reel slot games playable for 25c, 50c or $1.00, or multiples thereof or progressive schemes, etc.). The phone may also utilize hierarchical sub-menus whereby the user may press dial keys with letters corresponding to a selection in a given category which ultimately leads to the selection of particular gambling content. A phone having a screen display for providing a text listing of the categories and sub-categories of gambling content, according to hierarchical submenus, may also be used for enabling the user to narrow down to a list of files from which he can make his final selection.

### Examples of Gambling Content Files and Methods and Systems for Gambling Content Files to a Telephone

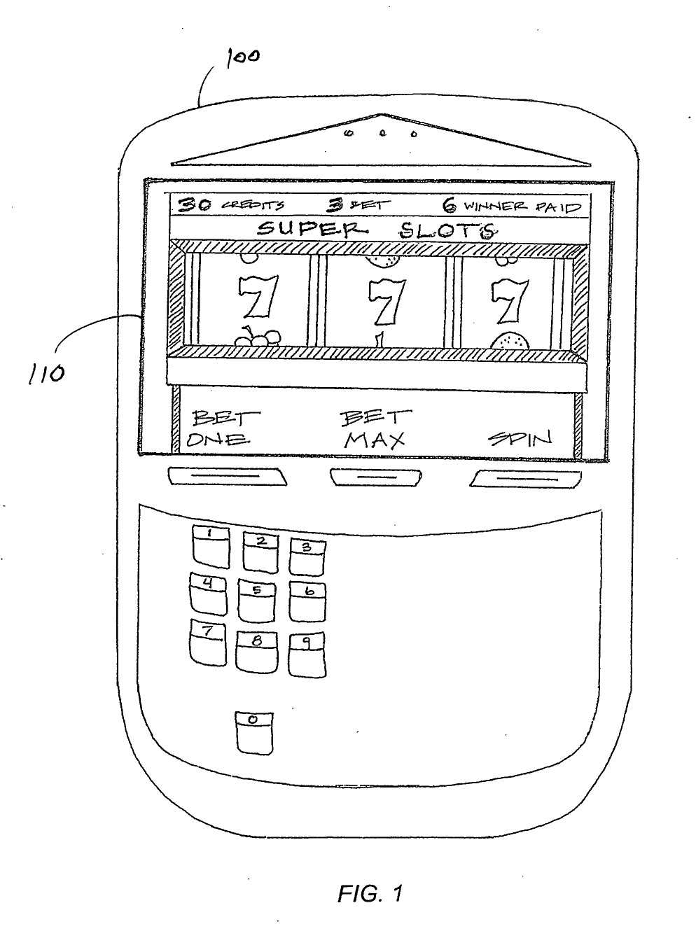

FIG. 1 is a perspective view of a cell phone 100 with a gambling activity depicted on its screen 110, which can be delivered wirelessly (or by wireline) in accordance with invention, with or without an Internet connection. The slot machine-type gambling activity depicted is only one of the very many such gambling embodiments possible with the invention, of which essentially all or possible.

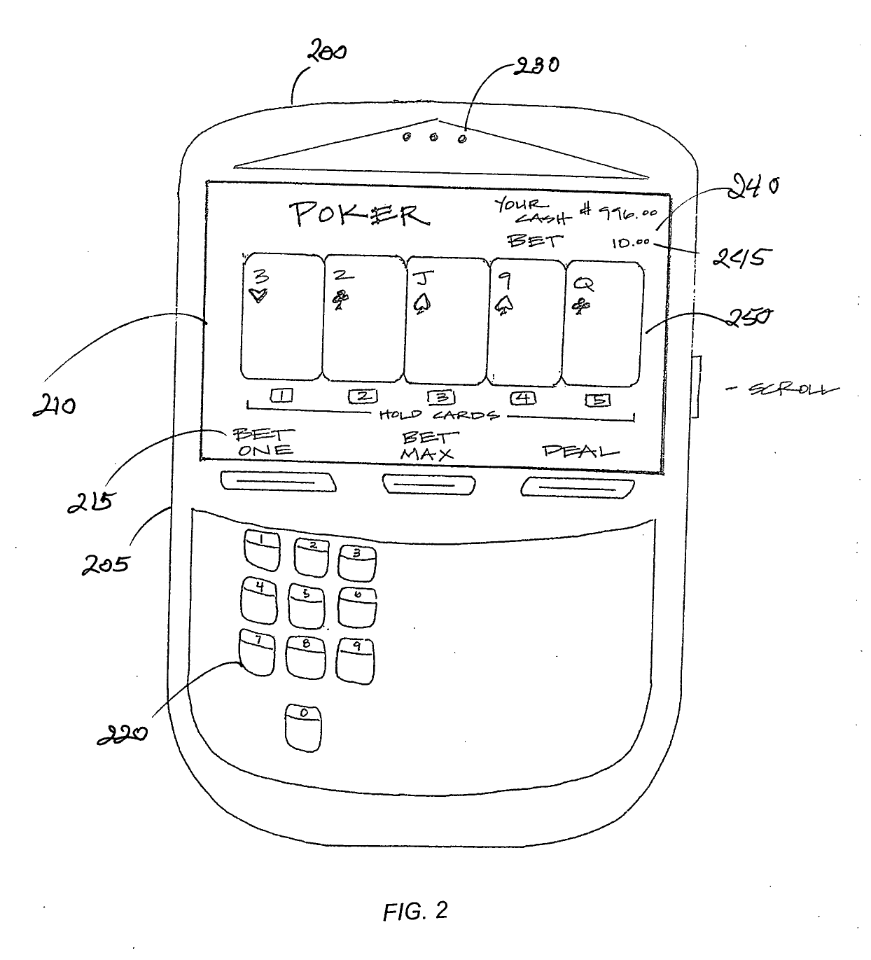

FIG. 2 is a another example embodiment of an aspect of the invention with a typical card gaming/gambling operation accomplished by downloading from a server to a phone device and/or operating same as a combination cell phone and gambling device which may proceed as follows: With reference to FIG. 2 illustrating a mobile gambling device 200 in its gambling operating environment, as shown, the device 200 comprises a housing 205 having a display screen 210 for viewing various visual applications presented by the device. The mobile gambling device 200 may be equipped with a stylus (not shown) that may be used to interact with touch points 215 on the display screen 210, or may be a “touch phone” with a touch screen where touch points 215 can be actuated by a person's finger, such as used on a iPhone type device and the like. The device 200 may include a built-in antenna (not shown), and may easily be used and be desirably portable with advantages of ease of use and convenience in accessing and delivery of mobile gambling content at virtually anyplace and time in contrast to Internet dependent devices, such as PCs and laptop devices, or netbooks, all of which must have an ISP connection. The embodiment of the mobile gambling device 200 illustrated in FIG. 2 takes the form of a cell phone, although other configurations that provide for portability are within the scope of the invention as well, an example of which, without limitation, is a personal digital assistant or PDA, tablet computer, netbook or any other portable device with telephone capability and service provider connectivity.

The mobile gambling device 200 is shown with function keys 220 and a program selector (not shown) that may be used, for instance, to select the type of game or gambling content a user wishes to play, or engage in the format in which the game or gambling content is presented, such as, without limitation, the size or magnitude of a bet placed. It should be understood that the mobile gambling device 200 may incorporate function keys on different areas of the housing than illustrated in FIG. 2, or alternatively, may be incorporated as a part of a system program that may be actuated on the display screen. In addition, a speaker/microphone 230 is illustrated on the housing 205, although, as with the function keys, the mobile gambling device may be provided with or without this feature.

In this non-limiting embodiment, the display screen 210 may also include a tool bar, such as in the form of a cell phone key pad or touch screen, or be capable of activation by verbal commands, utilized for system instructions and assistance. An account field 240 located somewhere on the screen 240 may be provided to the user as a running total of the amount that the user has available to wager such as seen in live or Internet casinos. Adjacent the account field 240 or somewhere else on the screen may also be located a current bet field 245 that provides an indication to the user of how much money has been wagered for the present gambling content engaged in, such as also seen in live or Internet casinos.

When in a gambling mode, the display screen 210 may present the particulars of the gambling content chosen for play. In the illustration of FIG. 2, the selected gambling content is a card game gambling content 250, with a content layout 250 depicted as similar to a layout found in card gaming in a conventional casino.

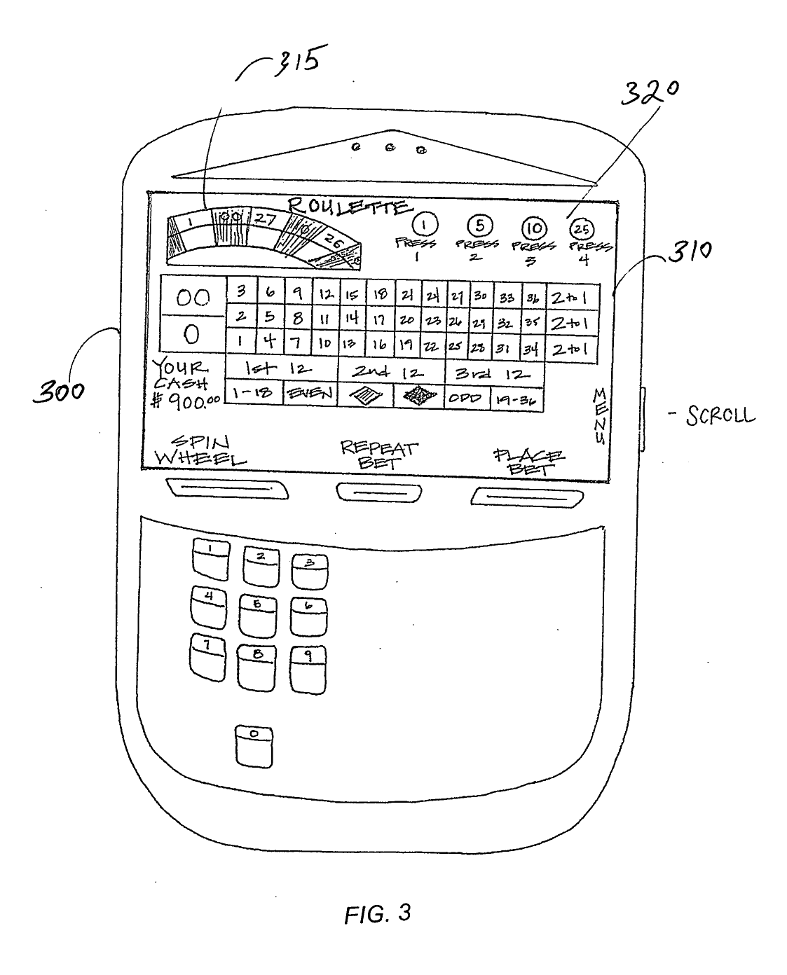

FIG. 3 is an additional example embodiment of an aspect of the invention illustrating typical roulette gambling operation accomplished by downloading from a server to a phone device and/or operating the cell phone comprising gaming operation in a similar manner as the gaming operation shown in FIG. 2, except here, the selected gambling content depicted 310 is similar to a layout found on roulette tables in a conventional casino, including a roulette wheel 315 shown (or a portion thereof) within display screen 320. As in FIG. 2 in this example, an indication board may be used to identify, in similar fashion to games or gambling played on a conventional roulette table, a list of numbers in previous games. There may be touch points (not shown) on the display screen 320, and which may offer operational icons such as those used to place bets.

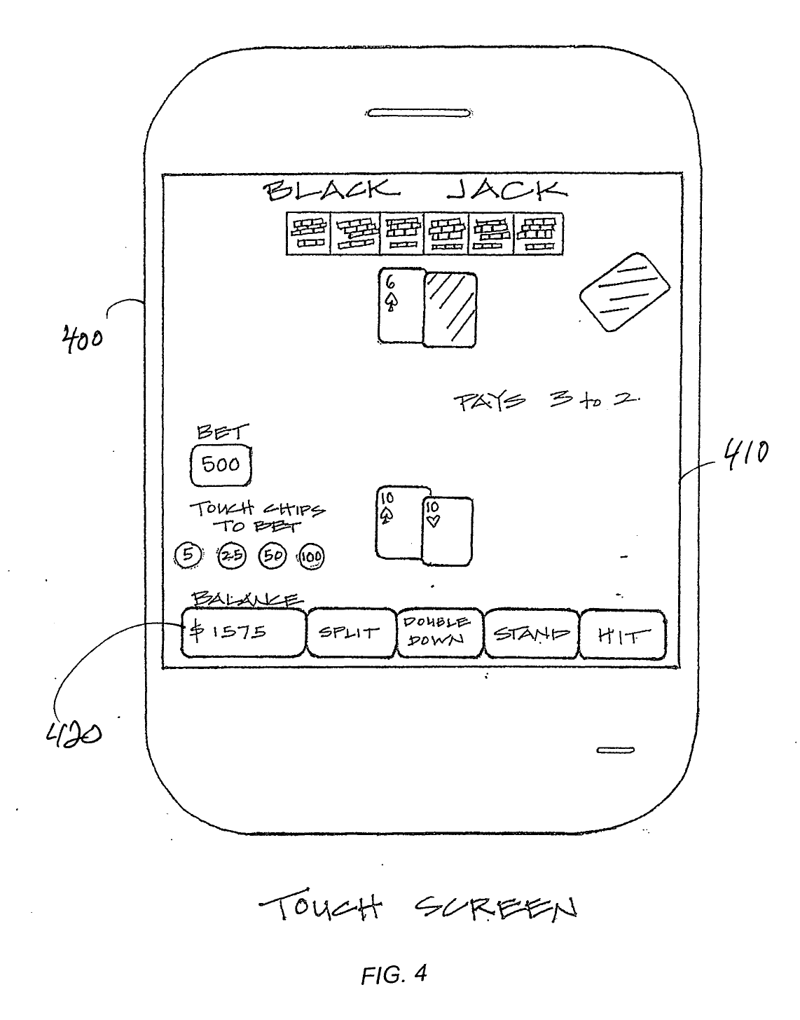

FIG. 4 is yet another example embodiment of an aspect of the invention illustrating a typical card game comprising a blackjack operation with phone device 400 with touch screen 410 equipped with touch points 420 for operating the blackjack game, and as in a conventional blackjack game, a dealer and player operating a bet screen portion and including, but not limited to, touch points, e.g. “touch chips” to place a bet.

Further in this example, an indicator board 260 is illustrated to identify, in similar fashion to games or gambling played on a conventional roulette table, a list of winning numbers in previous games. Touch points 215 on the display screen 210 may also offer operational icons 265 such as those shown to place bets on selected numbers.

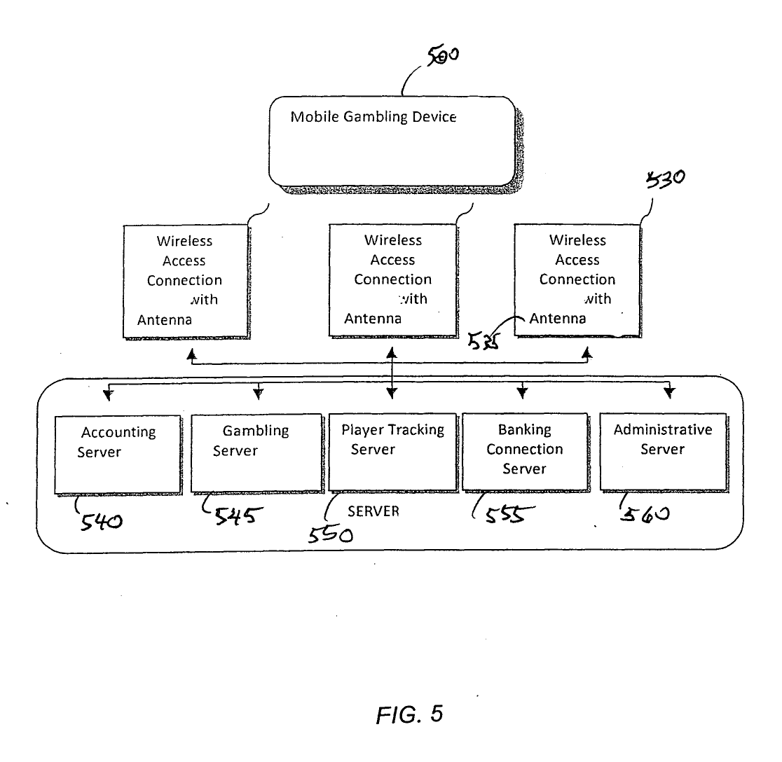

A mobile gambling device operation, such as any of those example embodiments shown above operating on a cell phone device, is further illustrated in block diagram form in FIG. 5 showing exemplified functional components thereof, including a wireless access connection 530 with antenna 535 in connectivity an accounting server 540, a gambling server 545, a player tracking server 550, a banking connection server 555, and an administrative server 560, all of which may be functioning with one or more servers combined. It should be noted that this is but one example embodiment, and other embodiments which do not depart from the scope of the invention may be and are enabled. In addition, the various features described herein may be enabled alone or in combination. It is important to reiterate that the mobile gambling device 500 may comprise any type of device capable of receiving and displaying information to a user that is received from a remote location with telephone capability and service provider connectivity.

As shown in FIG. 5, in this example embodiment, the mobile gambling device 500 is embodied to communicate over a wireless network. Accordingly, the mobile gambling device 500 may include an antenna 535 which connects to a wireless interface 530. The antenna 535 and wireless interface 530 or the wireless interface operate to receive signals transmitted from a remote location such as one or more hosting servers or gambling content or service providers to receive gambling content accompanied by rich media in compressed format, all of which is discussed more fully below in accordance with transmission of compressed data, as such is described in U.S. Pat. No. 7,548,875, the entirety which is incorporated herein by reference. As described above, other systems and methods for communication with a remote location are possible. The wireless interface 375 may perform such operations as decoding, demodulation, and other processing necessary to receive and transmit information in communication with a remote location.

One or more microprocessors or other computing device, inclusive of a DSP, and, for instance, an ARM, or ASIC, connects to the wireless interface 530 to perform an analysis and processing of data. The microprocessor may also connect to or communicate with a memory, a display screen, such as display screen 210 in FIG.1, and a user interface. The memory may comprise any form of memory capable of storing data. In various embodiments, the memory may comprise RAM, ROM, hard disk drive, flash memory, optical memory, CD or DVD ROM or a CD-RW media, again, such as more fully discussed below. In one embodiment of a mobile gaming device, the memory may be configured to store any and all of data, software code and programs, audio and video data, pictures, graphics, machine readable code and processor executable logic code.

A display screen may comprise any type of system configured to display information to a user. In another example embodiment, a display screen may incorporate touch screen capability for use by a user with a stylus or by finger touch, such as that illustrated in FIG. 3, or other pointing device to convey instructions through interactive input. A mobile gambling device may also include a microphone, such as that or other similar device in combination with a voice recognition system configured to allow a user to provide voice commands to the mobile gambling device to thereby control operation.

The user interface may optionally be included to provide access to additional systems for a user to enter information to the mobile gambling device. The user interface may comprise a track ball or mouse-type device, function keys or buttons (as in those identified as 225 in FIG. 2), a keyboard, microphone/speaker (i.e., number 230 in FIG.2), voice recognition system, pointing device, or any other device or system capable of receiving input from a user.

A power source connects to the microprocessor to provide power for operation as is known in the art. Although not shown, it is contemplated that the power source may also connect to other systems or components of the mobile gambling device as necessary to facilitate operation. A power source may be charged wirelessly by connecting to signals, such as from a power server source, such as by key pad or touch pad operation.

In operation, the mobile gambling device receives information by way of the wireless interface. Upon receipt, the microprocessor, i.e, a DSP and one or more other processors, may process the data to reformat the received data for viewing on the display screen or for use by a user as discussed in more detail below. The data received via the antenna and interface may be stored either temporarily or permanently in the memory.

A mobile gambling device may further be configured, such as using the systems shown in FIG. 5 to receive user input. More particularly, a user may provide user input to the system via the user interface or a touch-equipped display screen. Any type of information may be received from a user and it likewise may be stored in memory and/or transmitted to a server for processing and further storage.

It is contemplated that a mobile gambling system practiced in accordance with the present invention may be controlled by or in communication with one or more servers. The server comprises any type of computer system capable of storing data and providing data to one or more users over a network. The server may also provide processing operations. In one embodiment, the server includes database systems to store data regarding slot-type and other casino games, such as video poker, roulette, blackjack, craps, and any other wagering event, including lottery ticket, horse racing and the like.

The server communicates with a plurality of wireless access points to transmit and receive communications. Any number of wireless access points may be provided. It is contemplated that the wireless access points communicate with server through any form of wired or wireless communication between the access points and the server, again, as discussed more fully below.

The wireless access points may operate to communicate over wireless channels with one or more mobile gambling devices that are provided for use with a mobile gambling system. Any type of wireless transmission may be implemented including, but not limited to, radio or other frequency or electromagnetic energy, optical and infrared-type communication. Moreover, the wireless communication may occur under any type of standard or protocol, such as AMPS, IS-95, GSM, COPD, Mohitex, Ardis, IEEE 802.11, GPRS, UMTS, Bluetooth and/or other similar protocols, and in preferred embodiments configured to comprise OFDM methods and protocol.

The server may incorporate a variety of component servers that promote the useful operation of the mobile gambling system and methods of the present invention. More specifically, a gambling server is provided to facilitate the operation of the gambling content accessed by a user on the mobile database systems to store and transmit information related to individual or specific gambling content available to the user through the mobile gambling system or, alternatively, simply be programmed to determine a winning play and/or an appropriate payout. In the latter embodiment, the mobile gambling device may be pre-loaded with software for gambling content to achieve the functionality herein.

An accounting server may be provided to receive, store and transmit information relating to a user's account. More particularly, in a typical example operation, a user desiring to participate in mobile gambling would initially establish an account with the gambling operator or banking or debit account accessible by the user or gambling operation with funds deposited in an appropriate account with which to wager and engage in gambling activities. This initial investment may be recorded in the accounting server. It is contemplated that the accounting server may keep track of individual bets made by a user to note the draw down in a user's account, as well as replenishment deposits made by a user at various times, in similar manner as conventional live casinos. It is additionally contemplated in accordance with the embodiments and aspects of the invention that secure money exchange and/or transmission activities, such as procuring funds or money for gambling or wagering and the like or purchasing electronically available lottery tickets, such as scratch-offs, or for a gambling or wagering, or a sports book hosting site and the like or to make an automatic payout to a user's account in a “win” situation, be conducted in the accordance with the secure banking methods, system and products described in co-pending U.S. patent application Ser. No. 12/653,550, filed Dec. 15, 2009, for Mobile Banking Methods, the entirety of which is incorporated herein by reference.

A player tracking server may also be provided to assist in monitoring and processing gambling activities determining the location of a user when using the mobile gambling device, see, e.g. Mobile Banking Methods referenced above. The player tracking server may be configured in accordance with traditional player tracking programs which monitor player gambling and provide player rewards. The player tracking server may also be configured with software that aids in the decision as to whether or not to permit continued gambling or disable the mobile gambling device. For instance, the player tracking server may receive banking or playing information to be further processed toward the presentation of a wagering game. The player tracking server may also be configured with other locating means, such as GPS elements, to facilitate other location operations, such as for example, for use with targeted advertising and marketing content which can be pushed to the mobile user's phone before, during or after a gambling operation, such as discussed for example, in co-pending application Ser. No. 12/592,532 and related applications, the entirety of which are incorporated herein by reference.

Also contemplated herein is a gaming system, comprising: at least one or more processors inclusive of a DSP; at least one data storage device electronically coupled to the processor; and at least one gaming device in accordance with the invention in electronic communication with the processor, in which the data storage device is effective to store alert information or pushed or provided information associated with a gaming activity in the system is operable to recognize an event, the at least one processor is operable to generate an alert in response to the event, in which the alert comprises at least a portion of the alert information, and is further operable to forward the alert to the at least one gaming device for presentation to a user of the at least one gaming device.

Further contemplated herein is an apparatus comprising: at least one processors; and at least one data storage device electronically coupled to the at least one processor, the at least one data storage device operable to store: a program comprising instructions, and alert information associated with a gaming activity by a first user of a first mobile gaming device, the first mobile gaming device being in electronic communication with the at least one processor, the first mobile gaming device being operable to make a plurality of gaming activities available to the first user for play via the fi8rst mobile gaming device; wherein the program, when executed by the at least one processor, directs the at least one processor to at least: transmit gaming information to the first mobile gaming device; determine first information about a first location of the first mobile gaming device; store the first information about the first location of the first mobile gaming device; determine that the first user is engaged in the gaming activity at a game location based at least in part on the act of determining the first information about the first location of the first mobile gaming device; determine that an event has occurred, in which the act of determining that the event has occurred comprises determining a change in location of a second mobile gaming device used by a second user, the second user being associated in a database with the first user; responsive at least to (a) the determination that the event has occurred comprising the determination of the change in location of the second mobile gaming device and (b) the determination that the first user is engaged in the gaming activity at the game location, generate an alert based at least in part of the information about the first location of the first mobile gaming device, the alert comprising the alert information; and transmit the alert to the second mobile gaming device for presentation to the second user, the alert comprising information associated in a database with the first user.

### Example Schematic Diagram Illustrating the Basic Components for a Wireless Transmission System for a Telephone Having a Wireless or Landline Service Provider for Use in the Delivery and Play of Gambling Content

This example embodiment is but one non-limiting example, and is a system described in terms of components with reference to U.S. Pat. No. 7,548,875 and includes the following: a storage chip and a server. The storage chip is an element associated with the telephone which may be embedded into the phone or into an accessory unit which attaches to the phone, having abilities to interface with the phone, such as a gambling content accessory which may be purchased containing any particular gambling content desired such as slot or card games and the like. The existing hardware of a cellular phone may also be integrated with a software system which may be downloaded to the RAM element of the cell phone for incorporating the present invention, without the need for extra hardware. As such, the existing hardware of the cellular phone may be made to perform the same function of the chip.

The purpose of the chip is to receive delivery of and store one or more content files, including gambling content files, allow for downloading of e.g. gambling content files to be stored on the chip, and allow for the playback of gambling content files, particularly interactive playback, either by the telephone or the chip.

The server, which is associated with a collection of stored gambling content files, is designed to execute requests of the chip, which may be given through user voice commands or commands using the phone keys. The server may be equipped with a voice adapter for supporting the ITU-T V.253 standard and telephone lines attached to the voice adapter. The voice adapter can also support some standard modem protocols, like V.32 or V.34, if required for compatibility.

The server also allows for files to be transmitted to the chip for storage. The system enables a connection to the server upon a request from the chip, utilizing the phone, and/or PSTN (Public Switched Telephone Network), and/or a voice card (voice modem) attached to the server computer.

The system may have a voice menu, which, after connection to the server, allows the user to listen to the server's menu and navigate through the system of voice menus using the telephone's Dual Tone Multi Frequence (DTMF) keys. The system may allow the user to select and download gambling content files by allowing the user to listen and/or view gambling content files presented by the server, select gambling content files, and issue a download command to the server. The server then sends the selected gambling content files (e.g. in digital compressed form) using, for example, in one embodiment of this invention a Custom Data Transmission Protocol (CDTP) over the voice channel.

The system allows for storage of gambling content files in the chip's memory. The system's server utilizes a compression algorithm which converts common files into compressed files that are downloaded and stored by the chip. The chip may also have a sound output element such as speakers.

The server comprises software which can run under Windows 98, Windows-NT OS, or other suitable system using a voice modem for communications. Additionally, the system may use a single modem or a pool of several modems.

### Preferable Embodiments for a Telephone System

Examples of telephone systems utilizing the method of the present invention include a cellular phone which may utilize an analogue (voice-only) system or a digital system, and a conventional land line telephony network. A system for using a cellular network infrastructure, and a schematic diagram of a landline transmission system for a home telephone is shown in U.S. Pat. No. 7,548,875.

All described examples assume existence of one or more servers preferably dedicated for servicing user requests and providing gambling content files data download capabilities. A corresponding chip implementing all required functions is associated with the telephone.

The server may be a computer running Microsoft Windows or other suitable environment, such as a Pentium III PC, Win95/98/NT/2000, 128 Mb RAM, 4 GB HDD. The server may store or be capable of accessing a gambling content files database, which may be stored on a website or non-web holding unit. The gambling content files database is stored in a compressed file format of those commonly known.

An example schematic diagram for a server software system is shown in U.S. Pat. No. 7,548,875 for a cellular phone system. The software may be written in C++under Microsoft Windows or other suitable language. The functions of the server software include servicing user requests via a user interface element and transmitting selected gambling content files through the phone line via a gambling content files transmission element.

According to a preferred embodiment, the functions of the user interface element include decoding DTMF keys pressed by the user and playing the voice menu labels to the user. The voice menu interface may include hierarchical submenus, leading to different functions. In all examples, the user interface element can be unified in the sense that the voice interface and DTMF or voice recognition-based interface are independent of the type of network or type of phone(s) used. Implementations that utilize a single server to process requests originating from different types of networks and/or phones can therefore be built.

The system of submenus leads a user to the downloading of the selected gambling content files. Thereafter, control is transferred to the gambling content files transmission element for downloading gambling content files into the phone. The gambling content files transmission element interfaces directly with the phone accessory unit or the phone itself if so enabled, independent of the user. The gambling content files transmission element may be dependent or independent on the type of the phone used and the network infrastructure.

### Example Transmission System for a Cellular Phone and Network

An example schematic diagram of a wireless transmission system for a cellular phone is shown in U.S. Pat. No. 7,548,875, which may be either an analogue (voice-only) or digital system. In both cases, in a preferred embodiment, a board, implementing all required functions, similar to the chip, is incorporated in an accessory unit attached to the cellular phone, or may instead be embedded in the phone itself, or a software system may be integrated with the existing hardware chip of a conventional cellular phone without the need for additional hardware. The system further includes a server and software for the server.

In an advantageous aspect of the invention with capabilities far surpassing that of conventional or existing mobile gambling methods and systems, the cellular telephone may be any commercially available cellular phone, or “smart phone” having capabilities for supporting a command set for general telephone control, such as for instance, a V.25 Ter serial asynchronous automatic dialing and control as recommended by the ITU-T (International Telecommunication Union-Telecommunication sector)] and for supporting V.25 Ter “+C” extensions according to the ETSI (European Telecommunications Standards Institute) ETS300-916 standard for obtaining codes of keys pressed by the user and receiving caller ID information, or otherwise any modern smart phone preferably with 3G or 4G capability. Additionally, the phone should have capabilities for subscribing to a cellular provider, perhaps optionally preferably with caller ID service support.

The board may include the following main blocks: one or more processors including a digital signal processor (DSP), a flash memory element, a Random Access Memory (RAM) element, an initial bootstrap chip, an analogue interface element, and a digital interface element.

The processor executes the device firmware, provides control for all other blocks and performs the computational tasks for the board. The tasks performed by the processor include control of the board's units, monitoring of keys pressed by the user and processing of key-press events, reception of information from the computer through the computer digital interface, reception of caller ID information through the phone digital interface, reception of packed gambling content files through the phone analogue or digital interface, unpacking and then playing back content files, including gambling content files, through a built-in speakers and servers connected to the analogue interface of the unit, support of a voice menu-driven user interface, and performance of other auxiliary functions.

The flash memory element contains the device firmware, and gambling content files which can be pre-loaded and/or downloaded from a server as the case may be. The RAM element enables the processor to run faster and also holds buffers for unpacked gambling content and processor service procedures. When the power is turned on, the initial bootstrap chip loads the device.

The analogue interface element includes a phone interface element and a built-in speaker interface element and server element. The phone interface element is used for input and output of signals when downloading gambling content files from the server. The speaker interface element, with the speaker, plays all system sounds heard by the user including voice menus and those associated with gambling content files.

The digital interface element includes a phone interface element and may include a computer interface element. The phone interface element is used for phone control and for receiving key codes and caller ID information from the phone. The computer interface element is used for various service functions such as downloading preprogrammed gambling content files from the computer to the flash memory.

The functions of the server software include servicing a user's requests via a user interface element and transmitting selected gambling content files through the phone line via a gambling content files transmission element.

A user interface element is provided whose functions include decoding DTMF keys pressed by the user and playing the voice menu labels to the user. The voice menu interface may include hierarchical submenus which lead to the downloading of the selected gambling content files. Thereafter, control is transferred to the gambling content files transmission element for downloading gambling content files into the phone. The gambling content files transmission element interfaces directly with the phone accessory unit or the phone itself is so enabled, independent of the user.

The selected gambling content files may be transmitted through the phone line to the accessory unit (or the phone itself, if so enabled) first through the server hard drive, then through the server software, next through the voice adapter, then through the phone line of the network to the cellular service provider, to the cellular phone, and through the analogue interface of the accessory unit, then through the processor of the accessory unit, and finally, through the flash memory element of the accessory unit. When the gambling content files transmission is completed, the task of the gambling content files transmission element is completed. Thereafter, the phone line is released and control is transferred to the user interface element.

In an autonomous mode, the board may contain one or more pre-loaded gambling content files. Initially, the board is in the inactive state. The board and phone interact such that the phone sends to the board codes of all the keys pressed by the user. Upon receiving a particular sequence of codes or when, for instance, a particular key is pressed for a prolonged period of time, the board switches to the active mode. In the active mode the board may interact with the user via a voice menu-driven interface where voice messages, via a speaker, prompt the user to respond by pressing a selection of phone keys indicating the user's responsive selections. The board reacts to the user's selections by analyzing the keys being pressed.

Gambling content files may be stored on an internal gambling content files index situated on one or more servers or a phone device which can be retrieved from the internal memory of a server or phone device and played back according to key commands provided by the user. Examples of voice menu options provided by the device through a speaker upon switching to an active mode include: 1) the user may choose to exit the active mode and enter the passive mode (e.g., by pressing “0”); 2) the user may choose to listen to and/or view the current gambling content files on the gambling content files index (e.g., by pressing “1”); 3) the user may choose to listen to and/or view the next gambling content file on the index (e.g., by pressing “2”); or 4) the user may choose to listen to and/or view a previous gambling content files on the index (e.g., by pressing “3”).

In order to transfer digitally compressed gambling content files data through the analogue channel, a method and algorithm to map digits to sounds may be used. This method is implemented not only for a cellular telephone using an analogue cellular network but also for a landline transmission system of a home phone.

### Method for Data Transmission of Gambling Content Files over an Audio Channel of a Wireless Telephone

In another aspect of the invention, a data transmission method for transferring data through the phone line and the receiver, based on a voice mode connection (versus data mode) and DTMF signal interpretation is contemplated. A similar approach can be implemented for a landline telephone that does not have a data transmission mode.

In one embodiment for transmitting data through a phone line, the transmission method may comprise the steps of a) data scrambling, b) data mapping, c) conversion of frequency symbols to time samples, d) addition of cyclic prefix, and e) digital to analogue conversion. The data is then sent through the receiver, following the reverse steps of f) analogue to digital conversion, g) symbol synchronization, h) conversion of time samples to frequency symbols, i) decoding frequency symbols to bits, and j) descrambling the data.

The transmission method is used to provide enough speed for the data transmission. The transmission method advantageously allows simultaneous use of the voice communication and data transmission features (during one connection session) without having to switch the mode of connection. A user does not need to use a Wireless Internet Service Provider. A user can simply place a regular call to the specific number (e.g., an “800” number such as “1-800-gaming”) to gain access to the server to gain access and download gambling content to interact with as described. The dual-mode connection allows for voice and “push button” support as well as voice recognition service.

An orthogonal frequency-division multiplex (OFDM) modulation scheme may be used in yet another embodiment or an aspect of the invention for data transmission, which is the desired operation for use in 3G/4G and 4G smart phones. The benefits of OFDM include: 1) the modulation can be made robust to Inter-Symbol Interference (ISI) by increasing symbol size; 2) the modulation can be made robust to impulse noise by increasing symbol size; 3) for each individual sub-channel, the channel's response could be considered essentially flat, minimizing the need for channel equalization; and 4) different encoding schemes could be used for different sub-channels, for accommodating frequency-selective channel distortions.

The total bandwidth to be used by the method may be determined, for example, in a sound mode, by the worst case of supported audio channel. As an example, a suitable algorithm for compression of a voice channel is the GSM RPE-LTP algorithm which essentially has a built-in down-sampling by a factor of 3 in which the allowed bandwidth is limited at 4000/3=1333 Hz. Usually channel response is severely limited at frequencies below about 200 Hz to 250 Hz.

A compressed voice channel can also introduce significant non-linear distortions. Therefore, a large number of sub-channels may in some instances not be the most desirable operation, but still certainly contemplated, as the algorithm may sometimes be affected by inter-channel interference (ICI) due to loss of orthogonality between sub-channels. About 32 sub-channels appear to provide, in many instances, a good symbol size while maintaining satisfactory low ICI, but any and all are nevertheless contemplated.

### Modulation Symbol Structure

Each OFDM symbol preferably consists of a minimum number of samples sufficient to represent all sub-channels. To increase computation efficiency, a Fast Fourier Transform may be employed to convert sub-channel symbols from frequency to time area. Therefore, for 32 sub-channels, OFDM symbol size is preferably at least 64 real samples (at 2666 Hz rate). A circular prefix of 16 samples may be used to improve separation between symbols, and minimize ISI (Inter Symbol Interference) and ICI. Therefore, total symbol size may be, for example, 80 samples at 2666 Hz.

### Receiver Synchronization

Circular extension prefix redundancy, present in the signal, may be used to facilitate OFDM symbol synchronization in the receiver. A synchronization subsystem effectively computes auto-correlation coefficients of the received sequence (e.g., at 2666 Hz). The output of the correlator goes through a “rectifying” phase-locked loop-like system which outputs synchronization impulses at the proper time instants to sample OFDM symbols correctly.

Synchronization system induced timing jitter leads to rotation of received sub-channel phasors by increments, proportional to the central frequency of a particular sub-channel. This rotation is compensated in the decision scheme.

### Data Mapping

The output of a scrambler may be mapped onto complex symbols (amplitude/phase) of the OFDM sub-channels. Individual sub-channels use QPSK (Quadrature Phase Shift Keying) modulation.

### Data Scrambling

Data scrambling may be employed in order to provide statistically random distribution of transmitted symbols to reduce peak-to-average power ratio of OFDM symbols. A self-synchronizing scrambler with generating polynomial of is 1+x^{•-18}+x^{•-23} is used which, at the transmitter, effectively divides the data sequence by the generating polynomial. The coefficients of the quotients, taken in descending order, form the output data sequence.

### Example Using a Digital Cellular Network and Cellular Telephone for Downloading Interactive Gambling Content

The above-described cell phone or smart phone, so enabled, is used in this example in the context of digital (capable of providing a dedicated data transmission channel) cellular network. The server may use a modulation protocol compatible with the protocol supported by the cellular network provider. Usually this can be accomplished by using a standard ITU-T-approved modem, like V.32 or V.34.

Initially, the unit is in an inactive mode. A user dials the server number and, navigating through a system of voice menus or visual avenues supported by the server software listens to and/or views and selects a particular gambling content file in the same way as browsing the loaded gambling content files in the autonomous mode. The user may choose to download one or more gambling content files.

When a user, navigating through the server voice menus, selects to download the current gambling content files and activates the accessory unit through the pre-defined key sequence, the process of transmission of the selected gambling content files is initiated. After selecting a “download” option, the user may press a specific key combination on the phone to switch the accessory unit from the inactive to the active mode. The unit then begins to interact with the server, using the digital channel provided by the phone and the network. If possible, the already established phone connection is used, or a new connection is established specifically for digital data transmission.

The selected gambling content files may be transmitted through a phone line to the phone first through the server hard drive, then through the server software, next through the voice adapter-modem, then through the phone line of the network to the cellular service provider, to the cellular phone, and through the digital interface of the accessory unit, then through the processor of the accessory unit, and finally, through the flash memory element of the accessory unit. This is but one example and any wireless transmission to a cell phone or smart phone is contemplated.

Generally, the server software retrieves the selected gambling content files from a database, transfers codes of these files to the voice and/or image adapter-modem that converts these codes to actual sounds and visuals or images, using one of the standard modulation protocols supported by the cellular provider (like ITU-T Y.32 or Y.34) and transfers these files to the phone line. From the phone line, the files go to a cellular provider, where they are demodulated back into digital sound to the server as either an “acknowledgement” of a successful delivery of the gambling content files data or a list of data blocks received with errors so that these blocks can be resent in a second try. In order to transmit digital data through the analogue channel, a similar procedure is used to convert data to files and back.

When all the data is transferred without errors, the board signals to the server that the call may be disconnected. Thereafter, the server instructs the voice adapter to hang up, freeing the phone line for another client, and the board switches to the autonomous mode.

### A Data Transmission Method with Error Correction Delivery

A method for data transmission with error correction assumes a sufficiently low probability of error in the channel and implements error correction by re-sending the affected data blocks. The data (i.e. the compressed sound gambling content files) is split into smaller data blocks by the server. Each block is supplied with a special header that, in particular, includes the block number and a cyclic redundancy code word for error detection, computed for the block data and header. Other error detection codes can also be utilized. The data blocks are then sent through the data channel sequentially. Using the redundancy code, the receiver (ie. the mobile device) checks the correctness of each received block. The size of blocks is selected in such a way that 1) there is a high probability of error-free transmission of a block; and 2) the overhead introduced by additional control information (e.g. header, CRC word) is not high compared to the data payload.

If the block size is selected properly, only a few blocks out of the entire sequence are usually affected by channel errors. These erroneous data blocks are re-sent by the Server upon receiving special requests.

Depending on the availability of bi-directional data transfer, one of two protocols can be used. If the phone and network support simultaneous transmission of data in both directions, a protocol that uses simultaneous transmission of data in a server-to-phone direction and acknowledgements in a phone-to-server direction can be utilized. In this case, a special acknowledgement packet is sent for each valid data block received by the device. If a block is received with an error, a negative acknowledgement packet is sent.

The sever software, receiving these control packets, either sends the next subsequent data block, until all data blocks are transferred, or resends the block received with error. When all data blocks are transferred, and the positive acknowledgement is received for the last block, the sound gambling content files is considered to be completely delivered. An example of such interaction is shown in U.S. Pat. No. 7,548,875 for a protocol with individual packet acknowledgement for full-duplex channel, showing three data blocks 1600, 1602, and 1604 for corresponding data, indicated in the figure as “Data1” “Data2” and “Data3”, with corresponding headers “Hdr1”, “Hdr2”, and “Hdr3”. Positive acknowledgements “Ack1” and Ack2″ are sent for packets numbers 1 and 2. Packet number 3 is originally received with an error, indicated by “Nack” and is subsequently re-sent to successfully correct the error, whereby a positive acknowledgement “Ack3” is sent.

If the phone or network supports only unidirectional data transmission, the other protocol can be utilized to minimize the number of channel direction alterations. In this case, all data blocks for the sound gambling content files are sent at once by the server, without receiving acknowledgements for the individual packets. Then, a single control packet is transferred in the opposite (device to server) direction. This control packet contains a bit mask, with one bit for each data block received. Each bit in the bit mask has a “1” value if the corresponding data block was received without errors, or a “0” value if the corresponding block was affected by errors. The server then re-sends those blocks that were received with errors in the first pass. When all data blocks are transferred, and the acknowledgement mask without errors indication is received by the server, the sound gambling content files is considered to be completely delivered. An example is where the packet number 2 is originally received with an error and is successfully resent subsequently to correct the error.

### Preferred Procedure for Audio Data Parametric Optimization and Compression

The method of compressing the files comprises the steps of a) conversion b) amplitude normalization; c) sample rate conversion; d) pre-emphasis filtering; e) amplitude normalization; and f) performance of MPEG audio layer 3 (MP3) compression with the selected parameters. The compressed files are then transferred to the server database.

Step of conversion to mono only needs to be performed if the input file is in stereo and if the audio output subsystem of the target hardware is only capable of playing back mono audio. At this step all available information is included into the output audio by summing of the left and right channels to form a single mono output.

After conversion, or if the file does not need to be converted to mono, compression begins with the step of amplitude normalization, wherein sample amplitudes in the file are normalized. This step is required for enabling audio utilization of all available dynamic range and for improving the computational accuracy of subsequent steps. In order to maximize preservation of original audio range, a fixed coefficient for the entire audio file normalization is used. The coefficient is obtained using input file analysis to “stretch” the input audio range over the maximum available range.

Step converts sample rate of audio files to selected sampling frequency. The original audio gambling content files may have various sampling rates (44100 Hz, 48000 Hz, 22050 Hz, 11025 Hz, etc.). After analysis of available hardware capabilities an optimal sampling frequency, which provides the most adequate audio quality, is selected. Increasing the sampling frequency above the optimal sampling frequency would not significantly increase the perceptual audio quality, due to the limitations of the audio output subsystem of the accessory unit. For example, for the cellular phone system, after analysis of available hardware capabilities and a series of perceptual tests, the 22050 Hz sampling frequency was selected as providing the most adequate audio quality since the audio output subsystem of the accessory unit has a relatively sharp drop in response for frequencies above 10-12 kHz.

In order to avoid possibly non-desirious effects when changing from higher to lower sampling rate, a low-pass pre-filtering with a cutoff slightly lower than the new Nyquist frequency (or sometimes referred to as the folding frequency or cut-off frequency) may be applied before down sampling. For rates that are not multiples of each other, cascaded sampling rate conversion schemes may be constructed to minimize memory consumption and improve performance.

The step of pre-emphasis filtering, along with the re-sampling of the previous stage, takes into account the specifics of the audio output subsystem of the accessory unit, to achieve improvement of the perceptual audio quality, and to reduce the resulting audio size after compression.

Since the speaker of the audio output subsystem of accessory unit is preferably very small, the resulting sound has very low power in the low frequency range. Therefore, providing output in the low frequency range is likely to be futile, as it would only increase the size of audio file without any perceptual improvements. Additionally, providing output in the low frequency range may create undesirable “overflow” effects for the speaker.

For example, for the cellular phone system, all frequency content below about 400 Hz is removed from the audio. In order to make the audio more “perceptually rich” in the low-frequency range, frequencies around 600 Hz are increased by about +6 dB. The frequency range from 1200 Hz to 8200 Hz is kept unchanged. Then, starting from about 8200 Hz the signal power is gradually increased, up to +15 dB at the highest frequency (11 kHz). This compensates for the drop in speaker transfer function at high frequencies and improves the listening experience.

A set of subjective audio perceptual tests with various types of audio contents, using the wide spectrum of hardware of the target platform has proved that the above-described preemphasis significantly improves the perceptual quality of resulting audio. At the same time, reducing frequency contents in the “non-significant” frequency regions allows reduction of the resulting compressed audio size, since the data bits are not allocated to non-used frequencies.

The described pre-emphasis procedure is implemented by a filtering with a FIR (Finite Impulse Response) filter, according to the formula:

$${y}_{k} =. {\sum }_{i = 0}^{N - 1} {b}_{i} \cdot {x}_{k - i}$$

where bₗ are filter coefficients,

xₖ is the k-th output audio sample,

Yₖ is the k-th output audio sample.

The b₁ oefficients are fixed and computed for the particular sampling rate and the desired pre-emphasis response curve. The filter can be designed to have a linear phase response (this is actually guaranteed if the bₗ coefficients are symmetric), which would ensure absence of phase distortions to the audio. Since the delay introduced by the filter is not harmful for off-line processing, the filter size can be made rather large to approximate the desired response curve with a high precision.

After completing the step of pre-emphasis filtering, normalization of the sample amplitude is once again performed. Since the filtering significantly changes the signal, the second amplitude normalization step 1510 is required to convert resulting audio “loudness” to some pre-defined value.

Proceeding to step 1512, the processed audio gambling content files is compressed into an MPEG Layer 3 bit stream. The resulting bit rate (level of compression) can be varied to suit different needs. For instance, it can be made dependent on the source audio gambling content files length, to make the compressed file fit into a pre-defined size. Alternatively, it can be made dependent on the anticipated delivery method (to create, for instance, a “built-in” audio gambling content files of a very good quality, or to make the audio gambling content files of a very small size, for delivery through a slow channel). The compression parameters can also be selected so that the gambling content files delivery time is a constant independent of the actual link transfer rate.

### Technical Description of a Preferred Embodiment for a Cellular Phone Electrical Schematics

Possible embodiments of electrical schematics of a mobile phone which schematics can also be situated in an accessory unit are illustrated in U.S. Pat. No. 7,548,875. An image of the printed circuit board, as rendered by Computer Aid Design Software is also shown in U.S. Pat. No. 7,548,875. Initial boot-up of the processor is done from the EEPROM (Electrically Erasable Programmable Read Only Memory) using passive serial SPI (Serial Programming Interface) protocol. Thereafter, the boot loader code, read from the EEPROM, loads the main firmware from the Flash memory. The PLL (Phase Locked Loop) of the processor is programmed for 5× multiplication of clock frequency.

Firmware debugging is carried out through the JTAG (Joint Test Action Group) port using standard TI (Texas Instruments) software. External RAM is mapped both to the program and data space at the same addresses and occupies all lower address space (64 k). Flash memory (Serial Data Flash) is accessed using software emulation of SPI protocol.

Audio code (Coder-decoder) works at approx. 22 kHz sampling rate (both channels). The Mode Control transistor selects the phone interface mode: either RS-232 control mode (closed state) or “hands free” mode (opened state). The phone itself does not support simultaneous usage of these two modes.

Both channels of RS-232 work at 11,5200 baud rate. From the PC side CTS (Clear to Send) and DTR (Data Terminal Ready) signals are supported. From the phone side CTS and RTS (Request to Send) signals are supported, with inverted polarities. Both channels employ hardware flow control.

The analogue signal level at the phone input is about 100 mV RMS (Root Mean Square). The level at the phone output is about 600 m V RMS.

### Examples of Cellular Phone Embodiments Useful for Accessing and Downloading Gambling Content

A cellular phone, such as a smart phone or a cell phone, optionally equipped, for example, with a “gaming” or “gambling” accessory unit, according to different embodiments, are contemplated. If an accessory unit is used, such may be housed, for example, in thin cover providing a mounting body for attaching the phone to the unit, via an interface connector. The accessory unit contains the printed circuit board and speaker, preferably along the thin portion of the body, or such may be embedded in a phone unit itself.

The accessory unit may be attached to the back of the phone using the phone connector. A snap mounting which utilizes a dimpled section on the phone case typically intended for a car phone holder may also be used.

The accessory unit may include the server software and two voice modems, attached to the server. The mounting body contains all necessary electronic components.

The tasks of the electronic components include playing back of a pre-loaded sound gambling content files upon a caller ID notification reception and downloading new gambling content files from the server.

The PCB (printed circuit board), located inside a cell phone or an accessory unit in accordance with the invention as the case may be, may be a multi-layer board which may have, e.g. 0.2 mm gaps, two solder mask layers, and a silkscreen layer. The board preferably carries all the components, as illustrated in the schematics, excluding connectors and the speaker. Two outer layers of the board can be signal layers; two internal layers are ground and 3.3V power plane. For convenience of the PCB assembly on modem plants, most packages may be surface-mounted but not BGA. The board preferably does not contain any components requiring rare or custom-made equipment for their assembly.

A phone connector in the embodiment of employing an accessory unit is preferably selected to maximize the firmness of the attachment, taking into account significant dimensions of the accessory unit. It should be mentioned that the connectors are unique to the type of the phone used (Ericsson R520 and compatible, like R320 and T28, in this example).

Factors in selection of the speaker for music playback included sound quality, which is primarily related to the speaker size, compactness, and weight of the speaker, as it is desirable that the speaker not be thicker and heavier than the phone itself. Depending on the available technology, there may be some tradeoff between good speaker quality and having a lightweight speaker. Speakers used in professional radio receivers-scanners may be a reasonable compromise since such speakers provide better than usual sound quality while possessing reasonable dimensions and weight. Other options include either sacrificing weight and dimensions to increase sound quality or using the new so-called “ceramic” speakers that are now appearing on the market. Mention should be made that although using these speakers could provide better quality, special modifications to the device would be required since these speakers could not be directly substituted in place of the standard ones.

It should also be noted that the bandwidth of the acoustic channel of the cellular phone which, in turn, is non-linearly compressed and transmitted over a digital channel of the phone, is much less than the bandwidth of the conventional landline phone and can deliver about 150 bytes per seconds data transfer rate. Conventional landline phone could deliver about 3700 bytes per seconds (V.34). Using better speakers in the phone would entail loading sound fragments of better quality (and, therefore, of bigger size), which would increase the time necessary to download a melody. The problem could be solved by using the GSM digital data channel directly which would provide a rate of about 1000 bytes per second for existing cellular networks and more than 7000 bytes per second for newly deployed systems. Alternative solutions include: having to tolerate an increase in the sound file or sound gambling content files download time, downloading a melody from a local computer (the melody being delivered to the local computer by some alternate means), and redesigning the system to support conventional (landline) phones. In the latter case, due to the significant increase in the device body size, it may make more sense to use a stereo-effect (which is reasonable when the speakers of left and right channels have enough spatial separation).

### Server Software Description

The server described herein performs the following functions: 1) startup, detection of the modem, detection of the melodies available; 2) answering incoming calls; and 3) servicing requests of user via DTMF codes.

Upon startup, the application requests the user to select which device to work with. Possible options include local test mode (0), modem on COMI port (1), and modem on COM2 port (2).

If the local test mode is selected, all sounds will be played back using the sound card of the local computer and the computer keyboard will be used to control the server (via numeric buttons instead of DTMF keyboard). This mode is primarily for system testing purposes.

If one of the modems is selected, all sounds will be played back into the phone line using the selected modem, and the calling party's phone keyboard (DTMF tones) will be used to control the server. This is the normal mode of server operation.

The answering of incoming calls is performed differently in the local and the normal modes. In the local mode, the application waits for the ‘R’ key to be pressed to simulate remote party RING, while in the normal mode, the application waits for the RING signal from the modem. Then, in either mode, the application initializes the device used (sound card or modem). In the latter case, the modem goes “off-hook” and plays back the greeting message and the main menu (e.g., O-End of the session, I-Current, 3-Next, 4-Load).

Thereafter, the application goes into calling party servicing loop. Exit from the loop is possible upon reception of DTMF code ‘0’ (or its simulation using the keyboard) or after the 30-seconds timeout if no reaction is detected from the remote user. Additionally, if working with the modem, the loop is exited when short beeps (“BUSY”) condition is detected on the phone line. In the local mode, the ‘X’ key also leads to the immediate exit of the application.

The calling party servicing algorithm may work as follows: the software keeps the internal counter or number of the current sound gambling content files. Initially, this number is “0” indicating that the gambling content files is at the top of the list. Upon receiving the “1” command, the software plays back the gambling content files with the current number. Upon receiving the “2” command, the software increases the number and plays back the melody, i.e., plays the next melody. Upon receiving the “3” command, the software decreases the number and plays back the melody, i.e., plays the previous melody. Upon receiving the “4” command, the melody download is simulated. For the obvious reason, this mode is not implemented yet. Upon receiving the “0” command, the application switches the modem “on-hook” releasing the phone line and returns to the incoming call waiting state. Upon encountering any other command, the application plays back a standard error message. At any moment, the server application can be aborted by pressing <Ctrl>C combination on the keyboard.

The server application keeps a log file (e.g., named “ProgramName_N.Log”) where N is a port number. Therefore, if two instances of the application are started, one for the modem on COM1 and the other for the modem on COM2, two independent log files will be created. The log file contains brief information about user and server actions, times of events, their main features, for example, state of the modem or the sound card. These files are intended to be sent to the software developers in case of problems but can be used for other purposes as well, for example, to estimate the server load.

Due to the fact that the server application always plays a melody with the same quality as one would be able to hear through the conventional phone channel [monophonic, 8 kHz-sampling rate (signal bandwidth up to 3.7 kHz)], the sound quality of the played back gambling content files may be low. This is not related in any way with the quality of sound that would be digitally transferred to the client's phone when the melody is selected since listening to the gambling content files from server through the phone network could not deliver better quality than the phone channel itself. For this reason, sound files compressed in monophonic versus stereo form would be preferred since the rate of delivery would be faster, with no loss in playback quality from the phone. At the same time, when the gambling content files are downloaded into the phone in digital form, significantly better quality could be delivered upon playback due to the perceptual compression; however, this would increase the transfer time.

The server software could also be implemented to track which gambling content files were sent to which user or subscriber. This information could then be tracked and reported to different third parties such as the Copyright Office, or performing or artist's rights organizations or societies.

### Devices for Accessing Sound and Image Files

Electronic devices adapted to receive sound and image data, according to the present invention, may be provided with an attachment or built in mechanism for providing consumers with Internet based or Internet free access to a library of downloadable gambling content inclusive of sound and/or image files.

After hearing or viewing a gambling content file, the user, preferably by the push of a button, may transact a purchase of the full file associated with the gambling content files, which may be downloaded to the device in its entirety, or delivered to the user's address on an independent medium such as records, cassette tapes, CDs, videotapes, and DVDs. Such practice is intended to encourage the sales of sound and image files by giving the user the opportunity to quickly make an impulse purchase.

A device for downloading and listening to music files and/or sports betting or handicapping content, in addition to gaming content imagery and executable programs, which may appear similar to an I-pod™ device, but uses the same delivery method as described for the cellular phone in accordance with this invention comprises a speaker and/or an earphone set for listening to music with volume controls (such as Bose or Shure E5 universal earphones), and a server access element (which may be approximately the size of a credit card). Such a device may be used as a hand held portable music player, as well as a car radio or home system, and may include larger speakers for use as an audio system by businesses such as bars, restaurants and clubs.

In addition to features which allow a user to access the server library, the device may include other features common to conventional MP3 players and/or Apple I-Pod™ devices. The server access element includes controls, which may be buttons, for accessing, browsing, and downloading files from the server to the device. Speed dial technology may be used for accessing the server. For browsing, a multi-task arrows button which allows the user to browse, listen to samples, and highlight specific selections may be provided.

The server access element may include a small LCD monitor (approximately 1″×1.75″) for text browsing the server library. A small microphone hole may also be included for allowing the user to browse the library using voice commands. The earphone set or speaker will enable the user listen to downloaded sound files.

Downloaded files may be stored on a device storage list for accessing at all times, or deleted. Thus, the user may access a library containing a large number of sound files, and browse, download, and listen to music, without the Internet or the need to plug into a computer. The consumer may be charged a fee for each download, or may be able to purchase actual items, for delivery to an address indicated by the user, such as records, cassette tapes and CD's through the access element. Free gambling content files which the user can download may induce the consumer into purchasing the entire sound file from where the gambling content files originated.

The device may also include a mechanism for allowing a user to store downloaded files on a medium, such as a card, independent of the device. To this end, the device may provide a slot into which a storage card may be inserted, such that when the device is full, files may be downloaded onto the card for emptying space on the device. A security mechanism may also be included to prevent intellectual property abuse, for example, by preventing users from playing copied files on other devices as described above. Such devices may further include a monitoring feature, which would allow performing rights organizations such as ASCAP and BMI to keep track of music publicly played by business such as bars, restaurants, and clubs for the purpose of paying out royalties.

A schematic diagram for a media file monitoring system, according to a preferred embodiment, is shown in U.S. Pat. No. 7,548,875 for use with an I-Pod™ type listening device, wherein a consumer may purchase copyright registered media files which are downloaded wirelessly to the device. The system includes an existing wireless network of, e.g., 3G or 3G/4G or more, a system monitoring server, and a system content server. The monitoring server monitors and counts every file delivered to the consumer device, for monitoring and counting every file delivered to the device. The server may track each individually titled file which may include information such as song title and artist name, purchase price, the consumer's name, and other identity information, time of delivery, and any other pertinent information. The server may also protect encrypted copyrighted files from illegal file copying. The content server stores copyrighted digital media content licensed from multiple entertainment companies. Thereafter, monitoring information, including statistics may be transmitted (e.g. through the Internet) to a company or organization. The system described may also apply to a viewer device for monitoring image files.

A portable laptop type viewer device, for accessing and viewing image and/or sound files, may comprise a wireless earphone set and/or speaker for listening to programs with volume controls, and a Personal Digital Assistant (PDA) with a monitor which may be approximately the size of a laptop computer. This device allows the user to access a server library containing a large number of movies, TV shows, cartoons, and other files, using either text or voice activation, without the need to plug into a computer or use of the Internet or other computer based wireless telecommunication system.

The files may be categorized and subcategorized by type of file (i.e. movies, TV shows) then by title or name of main actors. TV shows may further be classified by providing a description for each episode, similar to a description provided in a TV Guide™. Other categories and subcategories of classification may be provided to allow the user to identify the exact file he wishes to access.

The device allows the user to browse, download, preview, store and view his selections, (using text, voice, or button commands), wherein a fee may be charged by the provider for any or all of these options. The files may be made available as gambling content files as well as in their entirety. The viewer device may include a folder containing previously downloaded image files that can be accessed at any time and deleted when desired. The library may be organized by categories such as type of show (i.e. movies, TV sitcoms), names of actors, show titles, sitcom description (e.g. as appearing in TV Guide™) etc.

### Method of Advertising using Delivery of Gambling Content Files

The method of delivering sound and image files, in accordance with the present invention, can further be utilized as an advertising tool. To this end, any of the above-described systems carrying the library of sound and/or image files, which include a website and non-Internet accessible holding unit, may be used to expose the user to sponsored advertising messages. For example, a user calling the holding unit may hear advertising while the system is accessing the library.

Other advertising opportunities may be provided by utilizing a phone or other electronic device using alerts according to the present invention. For example, the phone may ring with advertising gimmicks such as promotional messages. Such advertisement gimmicks may be played as default rings when no gambling content files is selected for the ring. Additionally, a phone may be programmed to play, or transmit advertisements spontaneously. Gambling content files containing advertising messages such as jingles may also be provided. Advertising messages may be tacked onto a user selected gambling content files of a popular song or the like.

While the present invention has been described with reference to a preferred embodiment or to particular embodiments, it will be understood that various changes and additional variations may be made and equivalents may be substituted for elements thereof without departing from the scope of the invention or the inventive concept thereof. In addition, many modifications may be made to adapt a particular situation or material to the teachings of the invention without departing from the essential scope thereof. Therefore, it is intended that the invention not be limited to particular embodiments disclosed herein for carrying it out, but that the invention includes all embodiments falling within the scope of the appended claims.

What is claimed is:

1. An electronic gambling, gaming, wagering and lottery content playing method and system comprising:
a storage medium effective to store gambling, gaming, wagering and lottery content files, including sound content files, image content files, or a combination thereof, in compressed format,
an electronic device having telephone capability and service provider connectivity comprising a receiver means which receives said content files delivered on demand in compressed format from a remote server with or without an Internet connection; and
a player located on the electronic device which can selectively play said content files, and wherein said content files are interactive in the form of a live casino, bingo or lottery operation.

2. The device of claim 1, wherein the receiver is a wireless device which receives said content files by way of wireless communication.

3. The device of claim 1, wherein the receiver has a hardwired connection to the internet for receiving said content files.

4. The device of claim 1, wherein the receiver receives said content files by way of a standard hardwired telephone network without accessing the internet.

5. The device of claim 1, wherein said content files comprise one or more of songs, musical compositions, cartoons, animation, movies, television shows, personal recordings, advertising content or a combination thereof.

6. The device of claim 2 wherein the device is a cellular phone.

7. The device of claim 1 comprising a collection of sound content files, image content files, or a combination thereof stored on the device.

8. A cellular phone comprising:
a receiving means for receiving pre-selected content files, in compressed format with or without an Internet connection and
a player to play said content files with the cellular phone and wherein said content files are interactive in the form of a live casino, bingo or lottery operation.

9. The phone of claim 8, wherein said receiving element means comprises software integrated with existing hardware of the cellular phone.

10. The phone of claim 8, wherein said player includes a software system integrated into existing hardware of the cellular phone.

11. The cellular phone of claim 8 enabled to process OFDM signals.

12. A gaming method comprising transmitting compressed gaming sound and/or image content files wirelessly to an electronic device on demand.

13. The method of claim 12 wherein said gaming content comprises one or more of gambling, wagering and/or lottery content, slots, card games, table games, keno, bingo, sports book, sports betting, horse and dog racing, exchange betting sweepstakes, scratch offs, and handicapping.

14. The method of claim 13 comprising transmitting by way of OFDM signals.
